(19) United States
(12) Patent Application Publication
(10) Pub. No.: US 2026/0097606 A1
(43) Pub. Date: Apr. 9, 2026

(54) CODE PRESENTATION ARRANGEMENT

(71) Applicant: TRANSACT ELEKTRONISCHE ZAHLUNGSSYSTEME GMBH, MARTINSRIED (DE)

(72) Inventor: MICHAEL KRAUS, ARGET (DE)

(21) Appl. No.: 19/114,188

(22) PCT Filed: Sep. 7, 2023
(86) PCT No.: PCT/DE2023/100663

§ 371 Date: Mar. 21, 2025

(30) Foreign Application Priority Data
Sep. 21, 2022 (DE) 10 2022 124 199.8

(51) Int. Cl. B42D 15/02; B42D 15/00; B42D 15/04; G06K 19/06

(52) U.S. Cl. CPC B42D 15/025; B42D 15/0073; B42D 15/042; G06K 19/06009

(57) ABSTRACT

A code presentation arrangement (10) consists of a carrier (20) and a card (30) attached to the carrier (20) or consists only of a card (30), wherein the card (30) or the carrier (20) respectively has a code presentation side (21b) on which a code (12) is applied. To enable more pleasant exposure of the code and more reliable detection of a code that has already been exposed, the code (12) on the code presentation side (21b) is covered by an opaque cover section (24) of the carrier (20) or an opaque cover section of the card (30), wherein the respective cover section is attached to the code presentation side (21b) by permanent adhesive strips (25) positioned along the edges of the code (12), and wherein the respective cover section in the area of the code (12) between the permanent adhesive strips (25) has a detachable tear-off tab (26) through which the code (12) can be exposed by pulling from the side facing away from the code (12).

### BACKGROUND

The present invention relates to a code presentation arrangement, which can be used, for example, as a voucher card.

Voucher cards usually have a card on which a code (e.g., PIN or activation code) and usually also a serial number assigned to the code for activating the code are printed, with the card often being attached to a carrier that can be hung on a hook in a warehouse. When the card is attached to a carrier, the code is usually printed on the side facing the carrier and the serial number can also be printed on the side facing the carrier or the carrier can have an open window to expose the serial number. When the voucher cards are distributed by the product provider in a store, the serial number is scanned by the cashier at checkout and transmitted to the product provider to activate the code. While the serial number is visible on the card, the code must not be made visible until after purchase, which is why the code printed on the card is conventionally covered by a scratch-off field consisting of a plastic layer and can be scratched off with a coin or finger from the card. Scratching off the cover usually creates fine dust and dirt, which is very unpleasant. In addition, the scratch-off field can be lifted with a knife to see the code and then reattached so that it is not noticeable to the buyer and cashier that the code has already been read by another person without authorization, which means that by scanning and transmitting the serial number at checkout, the other person can use the activated code without payment and in addition to the buyer.

SUMMARY The objective of the invention is to provide an improved code presentation arrangement in which, on one hand, the code can be exposed more pleasantly, but on the other hand, unauthorized exposure of the code is reliably detectable.

This objective is achieved by the invention objects defined in independent claims 1 and 9. Some advantageous embodiments and further developments of the invention are the subject of the respective dependent claims.

According to the invention, it is proposed not to cover the code with a scratch-off field made of a plastic layer, but rather to consider an opaque cover section in the respective existing element card or carrier, wherein the cover section has a detachable tear-off tab for exposing the code. With this structure of code coverage by already existing card or carrier, no additional components are needed. In addition, with this structure of code coverage, the code can be exposed more pleasantly by the buyer since pulling out the tear-off tab from the cover section is simple and without additional workpieces and no dust or dirt is created when pulling out the tear-off tab from the cover section. Furthermore, after exposing the code by pulling out the tear-off tab, it cannot be closed again in the same way so that it is clearly recognizable by an open or differently closed cover section that the code has already been exposed by another person.

The inventive code presentation arrangement can be referred to/used as a voucher card, gift card, POSA (Point of Sale Activation) card, prepaid card, transaction card, and similar. The code can have any effects in principle, for example as PIN, activation code, secret number, QR code, etc.

According to a first aspect of the invention, the code presentation arrangement consists of a carrier and a card attached to it, wherein either card or carrier has a code presentation side on which a code is applied (e.g., printed). The carrier and card are, for example, essentially rectangular in shape with their corners slightly rounded. In addition, optionally either card can be fully attached to the carrier or partially protrude over the carrier and optionally fully or only partially cover the side of the carrier. In this embodiment variant, the code presentation arrangement according to the invention is characterized by the fact that an opaque cover section of either the carrier or an opaque cover section of the card covers the code on its respective presentation side. The respective cover section is attached on the presentation side by permanent adhesive strips positioned along the edges next to the code, and the respective cover section has a detachable tear-off tab (e.g., slightly cut/perforated) within the area between these permanent adhesive strips through which pulling from the opposite side exposes the code. The respective cover section, at least within the area over the tear-off tab above the code, is opaque. Standardly, there may also be a recess in the carrier, optionally also in the card, for hanging up the presentation arrangement and/or optionally a serial number for activating the code printed (e.g., as a digit list or barcode, preferably freely visible) on one side of either the carrier or the card.

In one embodiment of this first aspect of the invention, the code is applied on the presentation side of the card; the card is attached with its presentation side to one side (front or back) of the carrier; and the code is covered by a cover section within the carrier. Depending on the positioning of the code on the card, the optional cover section is positioned either in an edge area or somewhere in the middle area within the carrier.

In this embodiment variant, the card is preferably detachably attached to one side of the carrier. With the detachable card, both sides can be designed with readable information. So when detaching the card from the carrier, the cover section firmly remains over the code. Thus, in this case, it is proposed that the cover section within the carrier is preferably detachable through at least one perforation within the carrier formed as a slit or holes to detach from the remaining part of the carrier.

Alternatively, the card can also be firmly attached to the carrier. In this case, the cover section then remains inside the carrier while tearing off the opposite side to expose the code.

In this embodiment variant, the materials are preferably selected in such a way that both the carrier and the cover section within the carrier are made of paper or cardboard, while the card is made of paper or cardboard, optionally also PVC or plastic.

In another embodiment of this first aspect of the invention, the code is applied on the presentation side of the carrier; the card is attached to the presentation side of the carrier; and the code is covered by a cover section within the card. Depending on the positioning of the code on the carrier, the optional cover section is positioned either in an edge area or somewhere in the middle area of the card.

In this other embodiment, the card is preferably detachably attached to the presentation side of the carrier. With the detachable card, both sides can be designed with readable information. So when detaching the card from the carrier, the cover section firmly remains over the code. Thus, in this case, it is proposed that the cover section within the card is preferably detachable through at least one perforation within the card formed as a slit or holes to detach from the remaining part of the card.

In this other embodiment, the materials are preferably selected in such a way that the carrier is made of paper or cardboard, and the card and the cover section within the card are made of paper or cardboard.

In another embodiment of this first aspect of the invention, the code is applied on a code presentation side of the card; the card has a base section, which is attached to one side of the carrier with its back facing away from the code presentation side; the card further has a fold section, which is folded over a fold line onto the code presentation side of the base section; and the code on the code presentation side of the base section of the card is covered by a cover section in the fold section of the card.

In this other embodiment, the materials are preferably also selected such that the carrier is made of paper or cardboard and the card and the cover section in the card are made of paper or cardboard.

According to a second aspect of the invention, the code presentation arrangement consists only of a card (i.e., without a carrier), wherein the card has a code presentation side on which a code is applied (e.g., printed). The card is, for example, essentially rectangular in shape with its corners slightly rounded. In this embodiment variant, the code presentation arrangement according to the invention is characterized by the fact that an opaque cover section of the card covers the code on the code presentation side. The cover section is attached on the code presentation side by permanent adhesive strips positioned along the edges next to the code, and the cover section has a detachable tear-off tab (e.g., slightly cut/perforated) within the area between these permanent adhesive strips through which pulling from the opposite side exposes the code. The cover section, at least within the area over the tear-off tab above the code, is opaque. Standardly, there may also be a recess in the card for hanging up the code presentation arrangement and/or optionally a serial number for activating the code printed (e.g., as a digit list or barcode, preferably freely visible) on one side of the card.

In this aspect, the materials are preferably selected such that the card and the cover section in the card are made of paper or cardboard.

In one embodiment of this second aspect of the invention, the card has a base section and a fold section, wherein the fold section is folded over a fold line onto the base section so that the code presentation side in the base section and the code presentation side in the fold section face each other. In this embodiment, the code can either be applied on the code presentation side in the base section of the card and covered by a cover section in the fold section of the card or applied on the code presentation side in the fold section of the card and covered by a cover section in the base section of the card. The fold section optionally fully or only partially covers the base section, and the fold line runs optionally along the transverse or longitudinal direction of the card.

In another embodiment of this second aspect of the invention, the card has a base section, a fold section, and a further fold section, wherein the fold section is folded over a fold line onto the base section, and the further fold section is folded over a further fold line onto the fold section so that the code presentation side in the fold section and the code presentation side in the further fold section face each other; the code is applied on the code presentation side in the further fold section of the card and covered by a cover section in the fold section of the card; and the fold section is detachable from the base section of the card through at least one perforation. The perforation is, for example, formed by slightly cutting or piercing the card into a slit or holes to detach the fold section. The fold section optionally fully or only partially covers the base section, and the further fold section optionally fully or only partially covers the fold section, and the fold line and the further fold line run optionally along the transverse or longitudinal direction of the card (same or different).

In another embodiment of this second aspect of the invention, the card has a base section, a fold section, and a further fold section, wherein the fold section is folded over a fold line onto the base section, and the further fold section is folded over a further fold line onto the fold section so that the code presentation side in the fold section and the code presentation side in the further fold section face each other; and the code on the code presentation side in the fold section of the card is covered by a cover section in the further fold section of the card. The fold section optionally fully or only partially covers the base section, and the further fold section optionally fully or only partially covers the fold section, and the fold line and the further fold line run optionally along the transverse or longitudinal direction of the card (same or different). Optionally, in this embodiment, the fold section is detachable from the base section of the card through at least one perforation, so that the fold section and the further fold section are separable from the base section. The perforation is, for example, formed by slightly cutting or piercing the card into a slit or holes to detach the fold section and the further fold section.

The invention is defined by the appended claims. The above and further features and advantages of the invention will become better understood from the following exemplary description of preferred, non-limiting embodiments based on the accompanying drawings. These show, partly schematically:

### BRIEF DESCRIPTION OF THE DRAWINGS

FIGS. 1A-D: A first embodiment of the code presentation arrangement according to the invention with a carrier [A: Front view, B: Rear view, C: Side sectional view, D: Perspective view after separation];

FIG. 2A: Top view of the code on the card;

FIG. 2B: Cross-sectional view of the code with cover;

FIGS. 3A-D: A second embodiment of the code presentation arrangement according to the invention with a carrier [A: Front view, B: Rear view, C: Side sectional view, D: Perspective view after separation];

FIGS. 4A-D: A third embodiment of the code presentation arrangement according to the invention with a carrier [A: Front view, B: Rear view, C: Side sectional view, D: Perspective view after separation];

FIGS. 5A-C: A fourth embodiment of the code presentation arrangement according to the invention without a carrier [A: Front view, B: Rear view, C: Side sectional view];

FIGS. 6A-C: A fifth embodiment of the code presentation arrangement according to the invention without a carrier [A: Front view, B: Rear view, C: Side sectional view]; and

FIGS. 7A-C: A sixth embodiment of the code presentation arrangement according to the invention without a carrier [A: Front view, B: Rear view, C: Side sectional view].

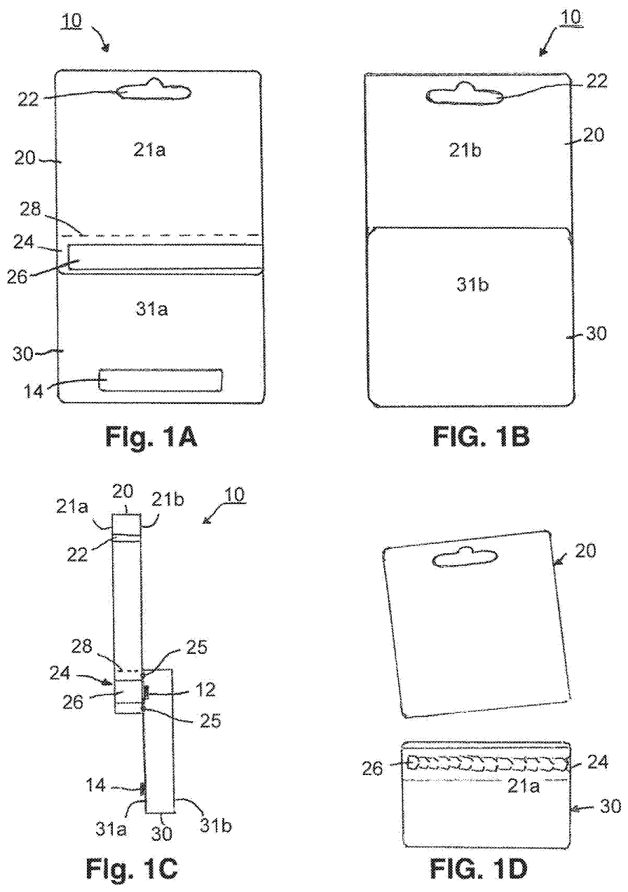

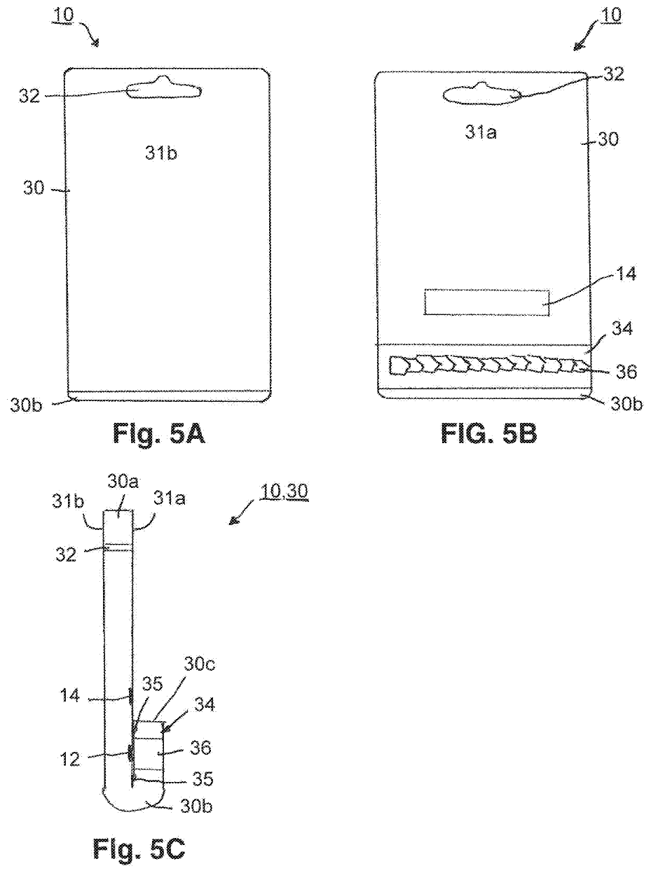

FIGS. 1A-4D each relate to the first aspect of the invention of the code presentation arrangement with a carrier and card, and FIGS. 5A-7C each relate to the second aspect of the invention of the code presentation arrangement with only a card (without a carrier).

### DETAILED DESCRIPTION

The figure groups show various embodiments of an inventive code presentation arrangement, each exemplified in the form of a voucher card, through which a code (e.g., PIN, activation code, secret number, QR code, etc.) (e.g., as a digit list or barcode) can be sold in a store, with the code being activated by the store's cashier by scanning an additional serial number present on the voucher card (e.g., in the form of a barcode) and forwarding the scanned serial number to the product provider of the code so that the code can be used by the buyer. In other applications of the code presentation arrangement, the additional serial number can optionally be omitted.

It should be noted that the side sectional view figures C of the figure groups each show unrealistic size ratios of the components, but it is more clearly recognizable where which components are present, connected to each other, and interact with each other.

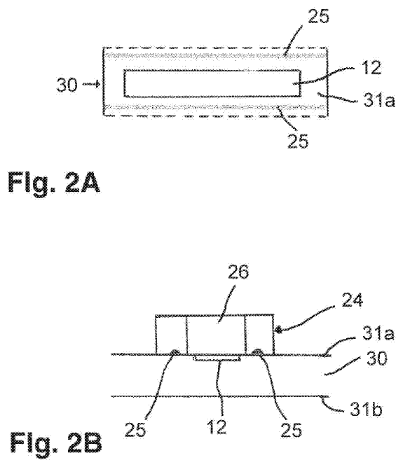

Furthermore, it should be noted that the illustration of the cover section in FIGS. 2A and 2B in relation to the first embodiment of FIGS. 1A-D fundamentally also applies to all other embodiments analogously.

The fold lines present in some embodiments can optionally also be designed/referred to as crease lines. On one hand, folding is referred to when the fold edge is created without tools; on the other hand, creasing is referred to when a sharp fold edge is created in paper technology with the help of a tool or machine. And the perforations present in some embodiments in the carrier or card are, for example, formed by slightly cutting or piercing the respective section of the carrier or card to enable easy detachment.

Referring to FIGS. 1A-D and 2A-B, a first embodiment of the code presentation arrangement according to the invention is now explained.

The code presentation arrangement 10 essentially consists of a carrier 20 and a card 30. The carrier 20 and the card 30 are each exemplarily rectangular in shape, with the corners slightly rounded. The carrier 20 and the card 30 are each made of paper or cardboard. The carrier 20 preferably has a recess 22 in its upper end area so that the carrier 20 and thus the entire arrangement 10 can be hung on a hook in a shelf or rack in the store.

In this embodiment, the card 30 has a code presentation side 31a, on which a code 12 is printed, and a back side 31b, and the carrier has a front side 21a and a back side 21b. The card 30 is attached to the carrier 20 in a lower end area and protrudes downwards over the carrier 20, with the code presentation side 31a of the card 30 attached to the back side 21b of the carrier 20.

To ensure that the code 12 is not visible, it is covered by an opaque cover section 24 of the carrier 20. As can be seen in FIGS. 1C and 2A-B, the cover section 24 contained in the carrier 20 is attached to the code presentation side 31b of the card 30 by permanent adhesive strips 25, which run alongside the code 12 along the edges of the code 12. The permanent adhesive strips 25 preferably extend over the entire width of the card 30 so that they protrude over the code 12 and securely hold the entire cover section 24 to the card 30. To expose the code 12 so that it becomes visible and can be used, the cover section 24 of the carrier 20 contains a detachable tear-off tab 26 in the area of the code 12 between the permanent adhesive strips 25, which can be easily (especially without additional elements) pulled out of the cover section 24. The cover section 24 is opaque at least in the area of this tear-off tab 26 above the code 12.

As illustrated in FIG. 1D, the card 30 is detachable from the carrier 20. To ensure that the cover section 24 of the carrier 20 continues to cover the code 12 when the card 30 is detached, the carrier 20 contains a perforation 28 at the edge of the cover section 24 so that the cover section 24 can be detached from the remaining carrier 20 and remains attached to the card by means of the permanent adhesive strips 25, thus covering the code 12. The code 12 is therefore usually only exposed after the card 30 is detached from the carrier 20 by pulling out the tear-off tab 26. In principle, however, the code 12 could also be exposed while the card 30 is still attached to the carrier 20.

Furthermore, for example, a serial number 14 for activating the code 12 is printed on the code presentation side 31a of the card in the section protruding over the carrier 20 (e.g., in the form of a barcode), with the serial number 14 being freely visible. In addition, some information for the user/buyer can be displayed on the arrangement 10. For example, the front side 21a of the carrier 20 contains information about the product name, the product provider, and the amount to be paid, and the sides 31a, 31b of the card 30 contain information about how to access the product via the code 12 and how the product can be used/executed.

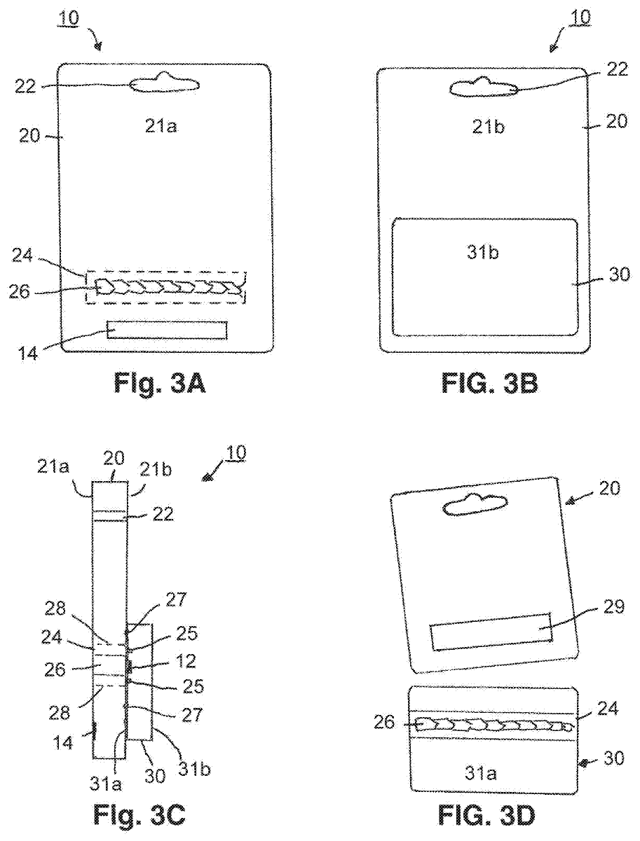

Referring to FIGS. 3A-D, a second embodiment of the code presentation arrangement according to the invention is now explained. The same or corresponding components are marked with the same reference numbers as in the first embodiment.

This second embodiment differs from the first embodiment essentially in that the card 30 does not protrude over the carrier 20 but is fully attached to the back side 21b of the carrier 20. Since the card 30 is also preferably detachable from the carrier 20 in this embodiment so that both sides 31a, 31b of the card 30 can be filled with visible information, the card 30 is attached to the carrier 20 outside the area of the cover section 24 of the carrier 20 by means of detachable adhesive dots 27. In addition, the carrier 20 contains a perforation 28 at the edges of the cover section 24 so that when the card 30 is detached, the cover section 24 can be detached from the remaining carrier 20 and remains attached to the card 30 by means of the permanent adhesive strips 25, thus covering the code 12. After the card 30 is detached, a corresponding hole 29 is present in the carrier 20 from which the cover section 24 is removed.

The serial number 14 is, for example, printed on the front side 21a of the carrier 20. Alternatively, the serial number 14 can also be printed on the back side 31b of the card. In both variants, the serial number 14 is freely visible, especially even before the card 30 is detached from the carrier 20.

Otherwise, this second embodiment corresponds to the first embodiment of FIGS. 1A-D.

Although not shown, in a variant of the second embodiment, the code 12 can alternatively be printed on the back side 21b of the carrier 20 and accordingly an analogous cover section 34 can be contained within the card 30. When the card 30 is detached from the carrier 20, the cover section 34 is then detached from the card 30 and remains on the back side 21b of the carrier 20 over the code 12.

Furthermore, although not shown, the card 30 can essentially fully cover the back side 21b of the carrier 20. Since the arrangement 10 is then essentially equally thick everywhere, this variant is advantageous when transporting the arrangement 10.

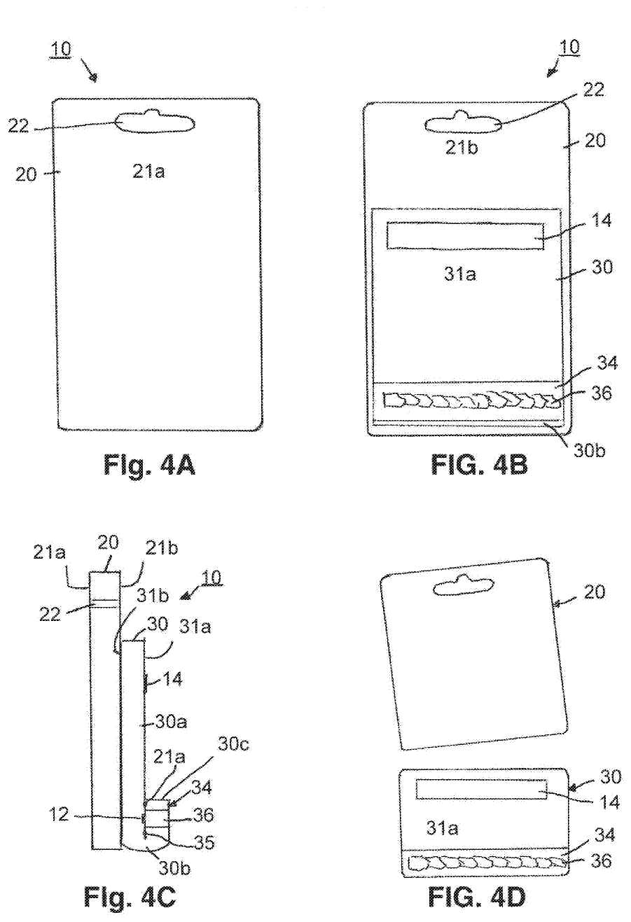

Referring to FIGS. 4A-D, a third embodiment of the code presentation arrangement according to the invention is now explained. The same or corresponding components are marked with the same reference numbers as in the first and second embodiments.

The code presentation arrangement 10 essentially consists of a carrier 20 and a card 30. The carrier 20 and the card 30 are each exemplarily rectangular in shape, with the corners slightly rounded. The carrier 20 and the card 30 are each made of paper or cardboard. The carrier 20 preferably has a recess 22 in its upper end area so that the carrier 20 and thus the entire arrangement 10 can be hung up.

In this embodiment, the card 30 has a code presentation side 31a, on which a code 12 is printed, and a back side 31b, and the carrier has a front side 21a and a back side 21b. The card 30 is essentially fully attached to the carrier 20 and does not protrude over the carrier 20, with the back side 31b of the card 30 attached to the back side 21b of the carrier 20, so that the code presentation side 31a of the card 30 faces away from the carrier 20.

Unlike the first and second embodiments, the code 12 on the code presentation side 31a of the card 30 is not covered by an opaque cover section 24 in the carrier 20, but by an opaque cover section 34 in the card 30. As illustrated in FIG. 4C, the card 30 for this purpose has a base section 30a, which is attached to the back side 21b of the carrier 20, and a fold section 30c, which is folded over a fold line 30b onto the code presentation side 31a of the base section 30a. The cover section 34 is arranged in this fold section 30c in the area of the code 12 applied on the base section 30a of the card 30.

Analogous to the cover section 24 in the carrier 20 in the first and second embodiments, the cover section 34 contained in the fold section 30c of the card 30 is attached to the code presentation side 31b of the base section 30a of the card 30 by permanent adhesive strips 35, which run alongside the code 12 along the edges of the code 12. The permanent adhesive strips 35 preferably extend over the entire width of the card 30 so that they protrude over the code 12 and securely hold the fold section 30c and, in particular, the entire cover section 34 to the base section 30a of the card 30. To expose the code 12 so that it becomes visible and can be used, the cover section 34 of the card 30 contains a detachable tear-off tab 36 in the area of the code 12 between the permanent adhesive strips 35, which can be easily pulled out of the cover section 34.

The cover section 34 is opaque at least in the area of this tear-off tab 36 above the code 12.

As illustrated in FIG. 4D, the card 30 is also preferably detachable from the carrier 20 in this embodiment. For this purpose, the base section 30a of the card 30 is attached to the back side 21b of the carrier 20 by means of detachable adhesive dots. When the card 30 is detached from the carrier 20, the fold section 30c of the card 30 remains folded over and attached to the base section 30a of the card 30, so that the cover section 34 of the card 30 continues to cover the code 12. A perforation in the carrier 20 or in the card 30 is not required in this context.

Furthermore, for example, a serial number 14 for activating the code 12 is printed on the back side 31b of the card 30 in the area of the base section 30a (e.g., in the form of a barcode), with the serial number 14 being freely visible. Alternatively, the serial number 14 could also be printed on the front side 21a of the carrier 20. Additional information can be displayed, for example, as in the first embodiment, on the front side 21a of the carrier 20 and the sides 31a, 31b of the card 30.

Referring to FIGS. 5A-C, a fourth embodiment of the code presentation arrangement according to the invention is now explained. The same or corresponding components are marked with the same reference numbers as in the previous embodiments.

Unlike the first, second, and third embodiments, the code presentation arrangement 10 in this case does not have a carrier 20. The code presentation arrangement 10 essentially consists only of a card 30. The card 30 is exemplarily essentially rectangular in shape, with the corners slightly rounded, and the card 30 is made of paper or cardboard. The card 30 preferably has a recess 32 in its upper end area so that it can be hung up.

The card 30 has a code presentation side 31a, on which a code 12 is printed, and a back side 31b. The code 12 on the code presentation side 31a of the card 30 is covered by an opaque cover section 34 in the card 30. As illustrated in FIG. 5C, the card 30 for this purpose has a base section 30a and a fold section 30c, which is folded over a fold line 30b onto the code presentation side 31a of the base section 30a. The cover section 34 of the card 30 is arranged in this fold section 30c in the area of the code 12 on the base section 30a.

Analogous to the cover section 34 in the third embodiment, the cover section 34 contained in the fold section 30c of the card 30 is attached to the code presentation side 31b of the base section 30a of the card 30 by permanent adhesive strips 35, which run alongside the code 12 along the edges of the code 12. The permanent adhesive strips 35 preferably extend over the entire width of the card 30 so that they protrude over the code 12 and securely hold the fold section 30c and, in particular, the entire cover section 34 to the base section 30a of the card 30. To expose the code 12 so that it becomes visible and can be used, the cover section 34 of the card 30 contains a detachable tear-off tab 36 in the area of the code 12 between the permanent adhesive strips 35, which can be easily pulled out of the cover section 34. The cover section 34 is opaque at least in the area of this tear-off tab 36 above the code 12.

Additionally, for example, a serial number 14 for activating the code 12 is printed on the code presentation side 31a of the card 30 in the area of the base section 30a (e.g., in the form of a barcode), with the serial number 14 not being overlapped by the short fold section 30c, so that it is freely visible. Alternatively, the serial number 14 could also be printed on the back side 31a of the card 30. In addition, some information for the user/buyer can be displayed on the arrangement 10. For example, the back side 31b of the base section 30a of the card 30 contains information about the product name, the product provider, and the amount to be paid, and the code presentation side 31a of the base section 30a of the card 30 contains information about how to access the product via the code 12 and how the product can be used/executed.

Although not shown, in a variant of the fourth embodiment, the code 12 can alternatively be printed on the fold section 30c and accordingly the cover section 34 can be contained in the base section 30a of the card.

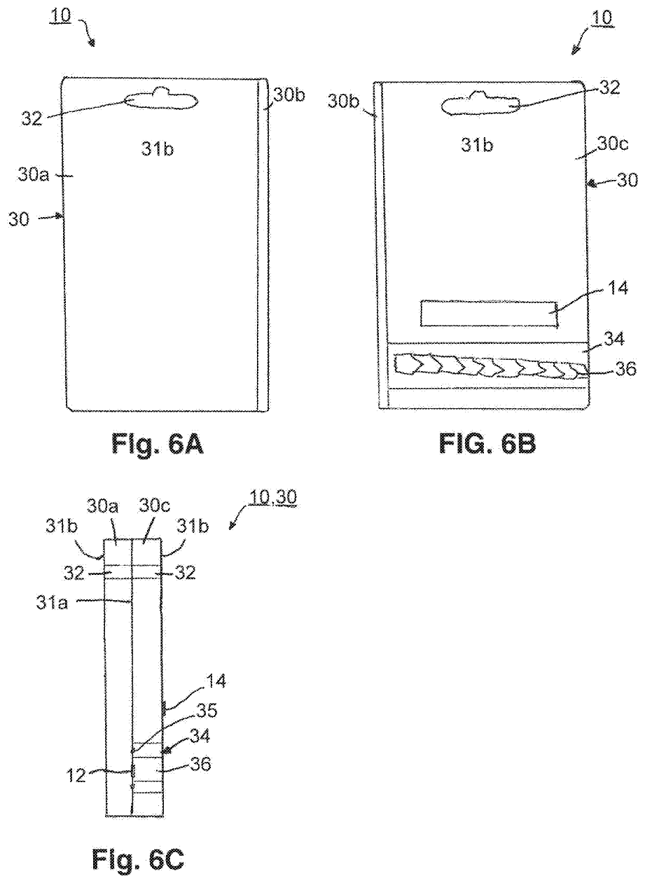

Referring to FIGS. 6A-C, a fifth embodiment of the code presentation arrangement according to the invention is now explained. The same or corresponding components are marked with the same reference numbers as in the fourth embodiment.

The fifth embodiment differs from the fourth embodiment in that the fold section 30c of the card 30a essentially covers the entire base section 30a of the card 30, and the fold line 30b runs in the vertical direction of the card 30 (instead of in the horizontal direction as in FIG. 5). Since the fold section 30c covers the entire base section 30a, the arrangement 10 is essentially equally thick everywhere, which is advantageous when transporting the arrangement 10.

Due to the complete overlap of the base section 30a by the fold section 30c, the recess 32 for hanging the card 30 runs through the base section 30a and also through the fold section 30c. The serial number 14 is, for example, printed in the area of the fold section 30c outside the area where the cover section 34 for the code 12 is present (or alternatively in the area of the base section 30a) on the back side 31b of the card 30. In addition, some information for the user/buyer can be displayed on the arrangement 10. For example, the back side 31b of the base section 30a contains information about the product name, the product provider, and the amount to be paid, and the back side 31b of the fold section 30c contains information about how to access the product via the code 12 and how the product can be used/executed.

Although not shown, in a variant of the fifth embodiment, the code 12 can alternatively be printed on the fold section 30c and accordingly the cover section 34 can be contained in the base section 30a of the card 30. Additionally, in the fifth embodiment, the fold line 30b can alternatively run in the horizontal direction (i.e., at the bottom edge in FIG. 6A).

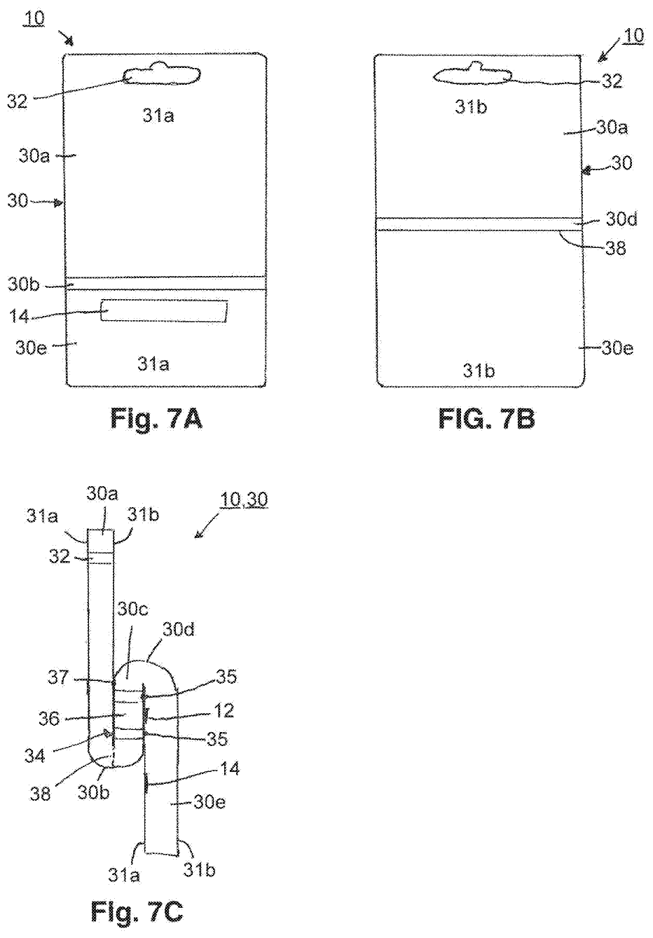

Referring to FIGS. 7A-C, a sixth embodiment of the code presentation arrangement according to the invention is now explained. The same or corresponding components are marked with the same reference numbers as in the fourth and fifth embodiments.

The sixth embodiment differs from the fourth embodiment essentially in that the card 30, in addition to the base section 30a and the fold section 30c, has a further fold section 30e. While the fold section 30c is folded over the fold line 30b onto the base section 30a, the further fold section 30e is folded over a further fold line 30d onto the fold section 30c. As illustrated in FIG. 7C, the fold section 30c can be relatively short, whereas the further fold section 30e is longer and thus protrudes over the fold section 30c.

In this embodiment, the fold section 30c is folded onto the base section 30a so that the back side 31b in the base section 30a and the back side 31b in the fold section 30c face each other, and the further fold section 30e is folded onto the fold section 30c so that the code presentation side 31a in the fold section 30c and the code presentation side 31a in the further fold section 30e face each other. Additionally, in this embodiment, the code 12 is printed on the code presentation side 31a in the further fold section 30e, and the opaque cover section 34 of the card 30 is contained in the fold section 30c. To make the tear-off tab 36 of the cover section 34 accessible and to remove it for exposing the code 12, the fold section 30c together with the further fold section 30e is detachable from the base section 30a. For this purpose, a perforation 38 is provided in the fold line 30b, and the fold section 30c is attached to the base section 30a of the card 30 by means of detachable adhesive dots 37.

The serial number 14 for activating the code 12 is, for example, printed on the code presentation side 31a in the protruding area of the further fold section 30e of the card 30 or alternatively on the code presentation side 31a in the base section 30a of the card 30 (e.g., in the form of a barcode). Additional information for the user/buyer can be displayed, for example, on the code presentation side 31a of the base section 30a, on the back side 31b of the further fold section 30e, and/or on the code presentation side 31a of the further fold section 30e in the area protruding over the fold section 30c.

Although not shown, in a variant of the sixth embodiment, the fold section 30c can extend over a larger area of the base section 30a of the card. Additionally, in this variant, the further fold section 30e can optionally extend only very briefly over the larger fold section 30c and contain the cover section 34 for a code 12 on the further fold section 30e. The design of the further fold section 30e with the cover section 34 over the fold section 30c with the code 12 then corresponds approximately to the design of the fold section 30c with the cover section 34 over the base section 30a with the code 12 according to the embodiment shown in FIG. 5C.

The invention is defined by the appended claims. The above embodiments explained with reference to the figures serve only to better understand the invention but are not intended to limit the scope of protection defined by the claims. As will be apparent to those skilled in the art, other embodiments are also possible within the scope of the invention defined in the claims, particularly by omitting individual features from the above-described embodiments or adding additional features to the above-described embodiments and by further (not explicitly mentioned) combinations of features from two or more of the above-described embodiments.

### REFERENCE NUMBER LIST

10 Code presentation arrangement (e.g., voucher card)
12 Code
14 Serial number
20 Carrier
21a Front side of the carrier
21b Back side of the carrier (possibly also code presentation side of the carrier)
22 Recess in the carrier for hanging
24 Cover section of the carrier over 12
25 Permanent adhesive strips for 24 on 30 next to 12
26 Tear-off tab in 24 between adhesive strip areas 25
27 Detachable adhesive dots between 20 and 30
28 Perforation of the carrier cover section from the carrier
29 Hole in the carrier after detachment of the cover section
30 Card
30a Base section of the card
30b Fold line between 30a and 30c
30c Fold section of the card
30d Further fold line between 30c and 30e
30e Further fold section of the card
31a Code presentation side of the card
31b Back side of the card
32 Recess in the card for hanging
34 Cover section of the card over the code
35 Permanent adhesive strips for 34 on 30a or 30c next to 12
36 Tear-off tab in 34 between adhesive strip areas 35
37 Detachable adhesive dots between 30a and 30c
38 Perforation of the cover section from the base section

1. Code presentation arrangement (10), comprising:
a carrier (20); and
a card (30) attached to the carrier (20),
wherein the card (30) or the carrier (20) has a code presentation side (31a, 21b) on which a code (12) is applied,
wherein an opaque cover section (24) of the carrier (20) or an opaque cover section (34) of the card (30) covers the code (12) on the code presentation side (31a, 21b);
wherein the respective cover section (24, 34) is attached to the code presentation side (31a, 21b) by permanent adhesive strips (25, 35) positioned along the edges of the code (12); and
wherein the respective cover section (24, 34) in the area of the code (12) between the permanent adhesive strips (25, 35) has a detachable tear-off tab (26, 36) through which the code (12) can be exposed by pulling from the side facing away from the code (12).

2. Code presentation arrangement (10) according to claim 1, wherein the code (12) is applied on a code presentation side (31a) of the card (30); the card (30) is attached with its code presentation side (31a) to one side (21a, 21b) of the carrier (20); and the code (12) is covered by a cover section (24) in the carrier (20).

3. Code presentation arrangement (10) according to claim 2, wherein the card (30) is detachably attached with its code presentation side (31) to one side (21a, 21b) of the carrier (20); and the cover section (24) in the carrier (20) is detachable from the carrier (20) through at least one perforation (28) in the carrier (20).

4. Code presentation arrangement (10) according to claim 2, wherein the carrier (20) and the cover section (24) in the carrier (20) are made of paper or cardboard, and the card (30) is made of paper, cardboard, PVC, or plastic.

5. Code presentation arrangement (10) according to claim 1, wherein the code (12) is applied on a code presentation side (21b) of the carrier (20); the card (30) is attached to the code presentation side (21b) of the carrier (20); and the code (12) is covered by a cover section (34) in the card (30).

6. Code presentation arrangement (10) according to claim 5, wherein the card (30) is detachably attached to the code presentation side (21b) of the carrier (20); and the cover section (34) in the card (30) is detachable from the card (30) through at least one perforation in the card (30).

7. Code presentation arrangement (10) according to claim 1, wherein the code (12) is applied on a code presentation side (311) of the card (30); the card (30) has a base section (30a) which is attached with its back facing away from the code presentation side (31) to one side (21a, 21b) of the carrier (20); the card (30) further has a fold section (30c) which is folded over a fold line (30b) onto the code presentation side (31) of the base section (30a); and the code (12) on the code presentation side (31a) of the base section (30a) of the card (30) is covered by a cover section (34) in the fold section (30c) of the card (30).

8. Code presentation arrangement (10) according to claim 5, wherein the carrier (20) is made of paper or cardboard, and the card (30) and the cover section (34) in the card are made of paper or cardboard.

9. Code presentation arrangement (10), comprising: a card (30), wherein the card (30) has a code presentation side (31a) on which a code (12) is applied, wherein an opaque cover section (34) of the card (30) covers the code (12) on the code presentation side (31a); wherein the cover section (34) is attached to the code presentation side (31a) by permanent adhesive strips (35) positioned along the edges of the code (12); and wherein the cover section (34) in the area of the code (12) between the permanent adhesive strips (35) has a detachable tear-off tab (36) through which the code (12) can be exposed by pulling from the side facing away from the code (12).

10. Code presentation arrangement (10) according to claim 9, wherein the card (30) has a base section (30a) and a fold section (30c), wherein the fold section (30c) is folded over a fold line (30b) onto the base section (30a) so that the code presentation side (31a) in the base section (30a) and the code presentation side (31a) in the fold section (30c) face each other; and the code (12) on the code presentation side (31a) in the base section (30a) of the card (30) is applied and covered by a cover section (34) in the fold section (30c) of the card (30), or the code (12) on the code presentation side (31a) in the fold section (30c) of the card (30) is applied and covered by a cover section (34) in the base section (30a) of the card (30).

11. Code presentation arrangement (10) according to claim 9, wherein the card (30) has a base section (30a), a fold section (30c), and a further fold section (30e), wherein the fold section (30c) is folded over a fold line (30b) onto the base section (30a), and the further fold section (30e) is folded over a further fold line (30d) onto the fold section (30c) so that the code presentation side (31a) in the fold section (30c) and the code presentation side (31a) in the further fold section (30e) face each other; the code (12) on the code presentation side (31a) in the further fold section (30e) of the card (30) is applied and covered by a cover section (34) in the fold section (30c) of the card (30); and the fold section (30c) is detachable from the base section (30a) of the card (30) through at least one perforation (38).

12. Code presentation arrangement (10) according to claim 9, wherein the card (30) has a base section (30a), a fold section (30c), and a further fold section (30e), wherein the fold section (30c) is folded over a fold line (30b) onto the base section (30a), and the further fold section (30e) is folded over a further fold line (30d) onto the fold section (30c) so that the code presentation side (31a) in the fold section (30c) and the code presentation side (31a) in the further fold section (30e) face each other; and the code (12) on the code presentation side (31a) in the fold section (30c) of the card (30) is covered by a cover section (34) in the further fold section (30e) of the card (30).

13. Code presentation arrangement (10) according to claim 9, wherein the card (30) and the cover section (34) in the card (30) are made of paper or cardboard.
